(19) United States
(12) Patent Application Publication
(10) Pub. No.: US 2009/0235992 A1
(43) Pub. Date: Sep. 24, 2009

(54) Method and apparatus for detecting water system leaks and preventing excessive water usage

(76) Inventor: Larry D. Armstrong, Eufaula, OK (US)

Correspondence Address: James T. Robinson;Exclusivity-Law, Inc., 222 East Main Street, Norman, OK, 73069-1303, US

(21) Appl. No.: 12/077,416

(22) Filed: Mar. 18, 2008

(51) Int. Cl. F16K 31/02; G01F 1/00

(52) U.S. Cl. 137/487.5; 73/861

(57) ABSTRACT

A method and apparatus for detecting water system leaks and preventing excessive water usage by water systems in residential and commercial buildings provides a processor-controller, a user interface for programming the processor-controller with preselected controller output criteria, and a water meter located in a water line within the building. The water meter provides a waterflow input signal to the processor-controller and closes a water line valve if the water usage calculated by the processor-controller satisfies the preselected controller output criteria. The present invention will activate a water-saving hot water for use in conjunction with a water heater in response to a user-entered occupancy schedule stored in the processor-controller. The present invention will monitor and contain water heater leaks and, in the event of substantial water leakage, will close valves in the water heater lines to prevent water losses into the building.

### BACKGROUND OF THE INVENTION

1. Field of the Invention

This invention relates to method and apparatus for detecting water system leaks and preventing excessive water usage and, more particularly, but not by way of limitation, to a method for detecting and preventing water leaks in residential and commercial structures. The present invention provides an alert when a leak is detected and initiates corrective action. If the invention detects conditions suggesting a leak is likely, e.g., freezing outside temperatures, the present invention takes preventive action, as predetermined by the user, to prevent the leak from occurring (e.g., by opening a valve to maintain a minimum water flow or by actuating a switch to energize a pipe-heater).

Water line breaks and water leaks, especially in an unoccupied or unattended building, result in damages to structures and personal property contained within the structures. Casualty insurance often covers losses resulting from water damage, and the cost of that coverage is built into insurance premiums charged by insurance companies. If the cost of coverage for water damage is excessive, some families may elect to exclude the coverage altogether. Property owners who have a mortgage will usually be required by the lender to insure against losses due to water damage, thereby increasing the mortgage payment and, in some cases, limiting home buyers' choices. With respect to commercial structures such as warehouses and manufacturing facilities, an undetected water leak may produce a large quantity of water which washes undesirable—perhaps toxic—materials into public areas and sanitary sewers.

2. Discussion

Every building plumbed with running water will eventually have a leak or a break in the line resulting in excessive water usage, together with damage to personal property and, on many occasions, to the building itself. Plumbing problems may not surface when the buildings' plumbing and fixtures are new. As buildings age, so do the plumbing pipes and fixtures. Even in relatively new buildings, water pipes in exterior walls are often exposed to freezing temperatures which can cause the exposed pipes to burst. Water heaters are especially prone to failures involving substantial water loss.

Modern security systems utilize proximity switches, motion sensors, and glass breakage monitors. Fire safety systems utilize smoke alarms and ionization sensors. Double setback thermostats permit occupants to adjust heating and cooling fortimes when the building is occupied or unoccupied based on the occupants' schedule. Yet nothing has been available to monitor water usage to detect leaks, line breaks, and equipment malfunctions which can lead to excessive water usage.

In the United States and most developed countries, water consumption is diurnal, i.e., peak periods of water usage occur between about 5:00 a.m. and 8:00 a.m. and then again in the evening hours between about 5:00 p.m. and 9:00 p.m. Most water usage is related to bathing activities and landscape irrigation. Outside of the peak use periods, most families do not use substantial amounts of water for drinking. Yet a break in a water line during off-peak hours discharges the same quantity of water as a water line break during peak usage periods. Moreover, breaks occurring during vacation periods, especially winter vacations periods, may go unnoticed until a vacationing family returns to a house severely damaged by water.

What is needed is a method and apparatus which will monitorwater systems, detect leaks, and prevent excessive usage of water.

### SUMMARY OF THE INVENTION

A method and apparatus for detecting water system leaks and preventing excessive water usage measures water usage and closes a valve in the water supply line if the water usage exceeds preselected criteria. A water meter provides an input signal to a controller. Based on preselected usage criteria entered through a user interface, the controller closes a valve in the water supply line. The controller also receives inputs from temperature sensors, fire detection devices, carbon monoxide monitors, and provides appropriate outputs.

An object of the present invention is to detect water leaks and initiate corrective action.

Yet another object of the present invention is to monitor water systems and take action to prevent water leaks.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a diagram of piping in a residential or commercial building showing meters and controlled devices according to the present invention.

FIG. 2 is a block diagram of a controller/processor according to the present invention showing input signals from meters shown in FIG. 1 to a controller/processor and output signals from the controller/processor to the controlled devices shown in FIG. 1.

FIG. 3 is a functional block diagram of the present invention.

FIG. 4 is another piping diagram.

FIG. 5 is a table listing conditions, inputs establishing the conditions, controller actions for the listed conditions, and device outputs associated with the listed conditions.

FIG. 6 is a table listing additional conditions, inputs establishing the conditions, controller actions for the listed conditions, and device outputs associated with the listed conditions.

FIG. 7 is a representation of an emergency breaker in a building's power supply line for use according to the present invention.

FIG. 8 is a representation of an emergency shutoff valve in a building's gas supply line for use according to the present invention.

FIG. 9 is a step-by-step description of the process by which the present invention detects and leak and responds to reduce the quantity of water lost as a result of the leak.

FIG. 10 is an administrative interface flow diagram summary.

FIG. 11 is a user interface flow diagram summary.

FIG. 12 is an alert interface flow diagram summary.

FIG. 13 shows a water saving hot water system for use according to the present invention.

FIG. 14 shows a hot water catchment for use according to the present invention.

FIG. 15 shows another hot water catchment for use according to the present invention.

### DETAILED DESCRIPTION OF THE INVENTION

In the following description of the invention, like numerals and characters designate like elements throughout the figures of the drawings.

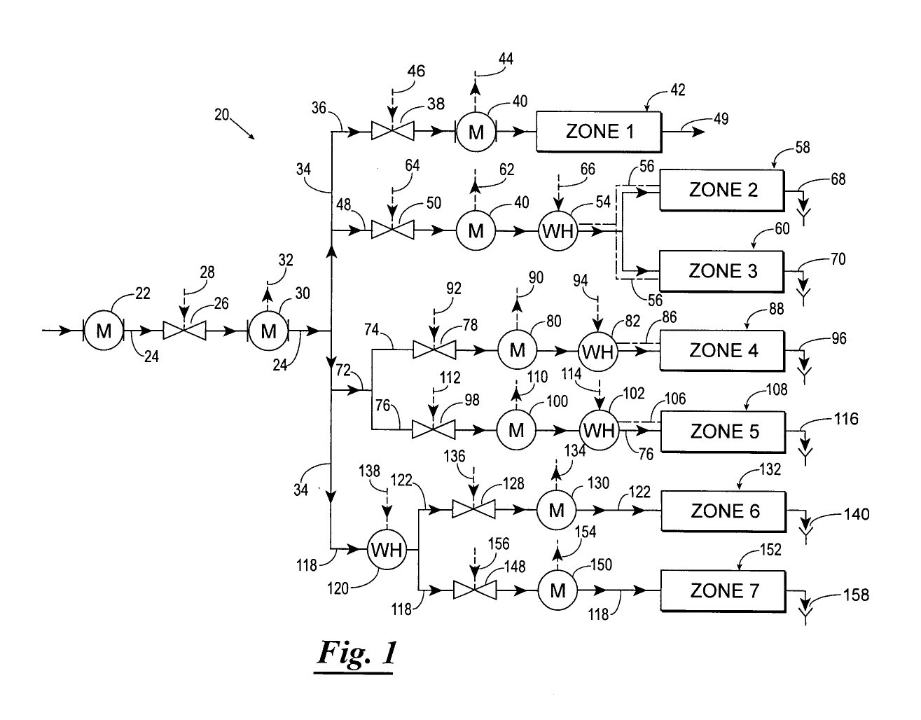

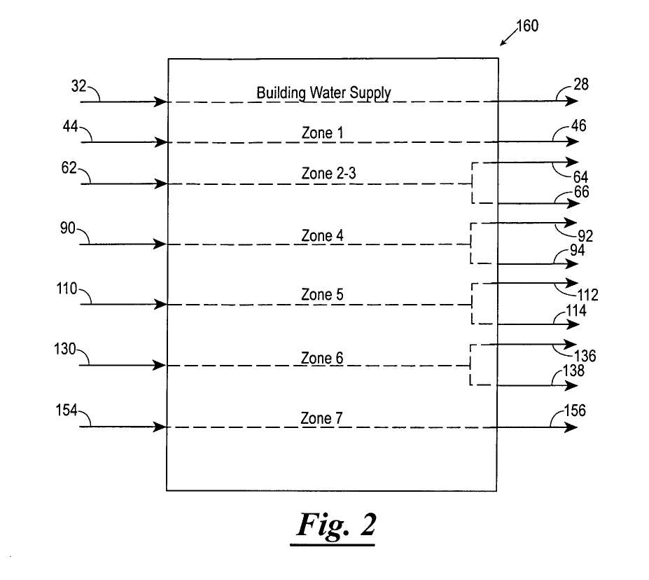

Referring generally to the drawings and more particularly to FIG. 1, a piping diagram 20 of a residential or commercial building shows a main water meter 22 from which a water supply line 24 supplies water to the building. The main water meter 22 is connected to a water system main (not shown). A control valve 26, controlled by an output signal 28 from a controller 160 (See FIG. 2) provides a main cutoff to the building water supply. A building water meter 30 provides an input signal 32 to the controller 160 indicating the flow of water to the building through the water supply line 24. The water supply line 24 connects the water meter 30 to a header 34, which, in turn supplies water to Zones 1-7 of the residential or commercial building. It will be understood by one skilled in the art that closure of the main cutoff valve 26 isolates the building from the main water supply.

Still referring to FIG. 1, a Zone 1 water line 36 supplies water, through a control valve 38 and a water meter 40 to Zone 1 (reference number 42) in the piping diagram 20. The water meter 40 provides an input signal 44 to the controller 160 (See FIG. 2), and the controller provides a corresponding output signal 46 to the control valve 38.

Referring still to FIG. 1, a Zones 2-3 water line 48 supplies water, through a control valve 50 and a water meter 52, to a water heater 54. From the water heater 54, the water line 48 supplies cold water to Zones 2 and 3 (reference numbers 58, 60, respectively). A hot water line 56 supplies hot water from the water heater 54 to Zones 2 and 3. The water meter 52 provides an input signal 62 to the controller 160 (See FIG. 2). The controller 160 provides an output signal 64 to the Zones 2-3 control valve 50 and an output signal 66 to the water heater 54.

Referring still to FIG. 1 and particularly to the portions of the piping diagram 20 relating to Zones 1-3, Zone 1 corresponds to an irrigation system, to exterior water faucets, or to a combination of an irrigation system and exterior water faucets. Zones 2 and 3 correspond generally to areas in residential or commercial building requiring hot water, such as laundry rooms, the kitchens, showers, and bathrooms. Excessive waterwill be consumed if an exterior faucet is left running or if the irrigation system is not turned off. Based on the input 44 from the water meter 40, the controller 160 (See FIG. 2) will produce an output 46 causing the Zone 1 control valve 38 to close, thereby limiting excessive water usage and damage resulting therefrom. Such an irrigation system normally discharges water to water beds and laws via a discharge 49.

Referring still to FIG. 1 and particularly to the portions of the piping diagram 20 relating to Zones 1-3, Zones 2-3 correspond to interior house piping wherein the water usage areas have been segregated into Zones 2 and 3 (58, 60). A single water heater 54 heats water for delivery to both Zones 2,3 via hot water line 56. If the controller 160 (See FIG. 2) determines water usage exceeds preselected criteria based on input from the water meter 52, the controller 160 will generate a first output signal 64 causing the Zones 2-3 control valve 50 to close and a second output signal 66 to turn off the water heater 66. The piping diagram 20 shows the water discharging from Zones 2, 3 via sanitary drains 68, 70, respectively.

Still referring to FIG. 1, a Zones 4-5 water line 72 branches into water line 74 (supplying Zone 4) and water line 76 (supplying Zone 5). The Zone 4 water line 74 supplies water, through a control valve 78 and a water meter 80, to a water heater 82. From the water heater 82, the water line 74 supplies cold water to Zone 4 (reference number 88), while a hot water line 86 supplies hot water from the water heater 82 to Zone 4. The water meter 80 provides an input signal 90 to the controller 160 (See FIG. 2). The controller 160 provides an output signal 92 to the Zone 4 control valve 78 and an output signal 94 to the water heater 82. Used water is wasted from Zone 4 to a sanitary drain 96.

Still referring to FIG. 1, the Zone 5 water line 76 supplies water, through a control valve 98 and a water meter 100, to a water heater 102. From the water heater 102, the water line 76 supplies cold water to Zone 5 (reference number 108), while a hot water line 106 supplies hot water from the water heater 102 to Zone 4. The water meter 100 provides an input signal 110 to the controller 160 (See FIG. 2). The controller 160 provides an output signal 112 to the Zone 5 control valve 98 and an output signal 114 to the water heater 102. Used water is wasted from Zone 5 to a sanitary drain 116.

It will be understood by one skilled in the art that portions of the piping diagram 20 relating to Zones 4 and 5 involve multiple water heaters 82, 102. A leak in Zone 4 resulting in closure of the Zone 4 control valve 98 would not affect either cold or hot water supplied to Zone 5. In commercial buildings and large residences, this approach will place water heaters near the points of use.

Referring still to FIG. 1, a Zones 6-7 water line 118 from the header 34 supplies water to a water heater 120. The water line 118 also supplies cold water to Zone 7. A hot water line 122 from the water heater 120 supplies hot water only, through a Zone 6 control valve 128 and a water meter 130 to Zone 6 (reference number 132). The water meter 130 provides an input signal 134 to the controller 160 (See FIG. 2). The controller 160 provides an output signal 136 to the Zone 6 control valve 128 and an output signal 138 to the water heater 120. Used water is wasted from Zone 6 to a sanitary drain 140. The water line 118 supplies cold water only, through a Zone 7 control valve 148 and a Zone 7 water meter 150, to Zone 7 (reference number 152). The water meter 150 provides an input signal 154 to the controller 160 (See FIG. 2). The controller 160 provides an output signal 156 to the Zone 7 control valve 148. Used water is wasted from Zone 7 to a sanitary drain 158.

Referring still to FIG. 1, and especially to the portions of the piping diagram 20 relating to Zones 6 and 7, the segregation of hot and cold water into separate zones permits independent control of hot and cold water.

Referring now to FIG. 2, a controller 160 receives inputs from the meters 30, 40, 52, 80, 100, 130, and 150 shown in FIG. 1. For each input, the controller integrates the flow rate (from the meters) with respect to time and determines the water usage. If the water usage exceeds a preselected maximum for the designated zone, the controller generates an output. As used herein, the terms “controller,” “processor,” and “controller/processor” are used interchangeably to indicate a device which receives inputs from users, meters, and sensors, processes the inputs, and provides a predetermined output if preselected criteria are satisfied.

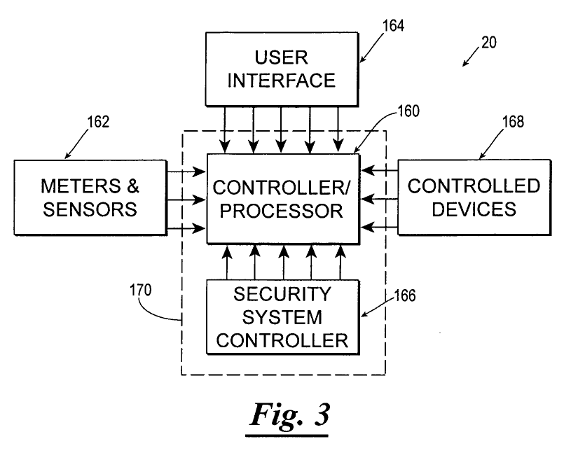

Referring now to FIG. 3, a block diagram provides a concise summary of the functions of the present invention 20. Meters and sensors 162 provide data-containing input signals to the controller/processor 160. The controller/processor 160 receives instructional inputs from the user interface 164. If the user has a security system, the controller/processor 160 can receive inputs from the security system controller 166. The controller/processor 160 processes the inputs according to internal software and, if preselected criteria are satisfied, generates outputs to controlled devices 168.

It will be understood by one skilled in the art that the user interface 164 may be a keypad similar to keypads used in residential and commercial security alarm systems. In the alternative, the user interface 164 can be an appropriately configured computer. It will also be understood by one skilled in the art that the security system controller 166 and the controller/processor 160 of the present invention can be combined in an integrated controller/processor 170.

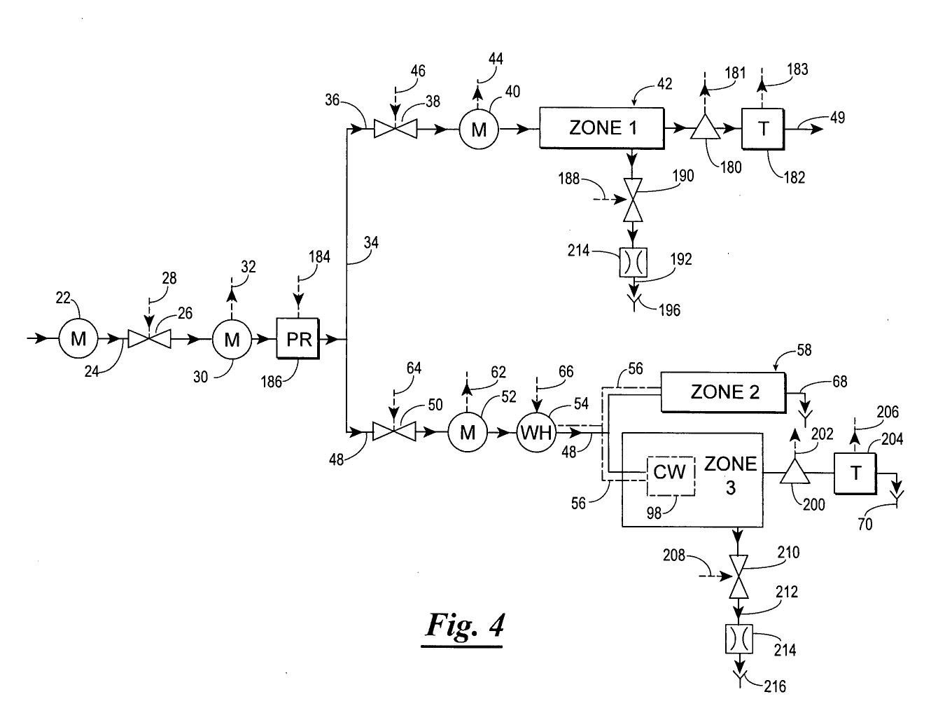

Referring now to FIG. 4, another piping diagram includes all the elements of Zones 1-3 (See FIG. 1), together with additional sensors providing input signals to the controller processor 160 and additional controlled devices receiving output signals from the controller-processor 160. For purposes of illustration, the piping diagram shown in FIG. 4 corresponds generally to a residence wherein Zone 1 piping supplies water to exterior faucets and an irrigation system. Zones 2 and 3 are within the building, and Zone 3 piping supplies water to a clothes washer located along an exterior wall in a laundry room.

Referring still to FIG. 4 and especially to the Zone 1 portion of FIG. 4, a pressure sensor 180 measures the pressure in the Zone 1 water line 36 and transmits a corresponding signal 181 to the controller-processor 160. A temperature sensor 182 measures the temperature in the Zone 1 water line 36 and transmits a corresponding signal 183 to the controller-processor 160. If the pressure in the Zone 1 water line 36 exceeds a predetermined acceptable line pressure, as entered by the user, the controller-processor 160 provides an output signal 184 to a pressure regulator 186. In the alternative, the pressure regular valve 186 can be selected based on a fixed reduced pressure. If the temperature is less than a predetermined temperature as entered by the user, e.g., 34 degrees Fahrenheit, the controller-processor 160 provides an output signal 188 to a valve 190 located in a drip line 192. A flow controller 194 located in the drip line 192 limits the flow to a water stream sufficient to avoid frozen water pipes. The drip line stream of water is discharged to a drain 196.

It will be understood by one skilled in the art that external faucets and irrigation piping are especially susceptible to freezing. In the case of an unoccupied residence, the actuation of the valve 190 in the drip line 192 by the controller-processor 160 may be the only mechanism available to avoid frozen pipes. It will also be understood that heating tape can also be used to prevent frozen pipes, wherein the controller-processor 160 switches on electrical power to the heating tape when the temperature of the water line 36 approaches 32 degrees Fahrenheit.

Still referring to FIG. 4, it will be further understood by one skilled in the art that opening the valve 190 in the drip line 192, to discharge water from Zone 1 piping and thereby avoid frozen pipes, may be determined by the controller-processor 160 to indicate a water leak and result in closure of the Zone 1 water line valve 38. To avoid this, the controller-processor 160 will be programmed to disable the leak detection function whenever the valve 190 in the drip line 192 is opened. It will be further understood by one skilled in the art that the placement of the temperature sensor 182 in the water line 36 is discretionary on the part of the user. Generally, most homeowners can identify the piping sections most likely to freeze. Placement of insulation around the temperature sensor 182 in a section of water line 36 most likely to freeze will help to avoid discharges of water through the drip line 192 resulting from transitory low temperatures.

Referring again to FIG. 4, the Zone 2 piping is identical to the Zone 2 piping in FIG. 1, thereby illustrating the fact that some zones will require neither a temperature sensor (if the piping is not exposed to freezing temperatures) nor a pressure sensor (if the piping is, for example, the farthest point in the system from the water supply line 24. In most cases, it is anticipated that a single pressure sensor placed in an appropriate location will protect the entire water system from piping failures due to excessive line pressure.

Referring still to FIG. 4 and especially to the Zone 3 piping, a clothes washer 198 is used to suggest piping near an exterior wall with a possibility of frozen pipes (and resulting leaks) during freezing conditions. A pressure sensor 200 provides an input signal 202 to the controller-processor 160. If the pressure in the Zone 3 water line 48 exceeds a predetermined maximum line pressure, as entered by the user, the controller-processor 160 provides an output signal 184 to the pressure regulator 186. A temperature sensor 204 measures the temperature in the Zone 3 water line 48 and transmits a corresponding signal 206 to the controller-processor 160. If the temperature is less than a predetermined temperature as entered by the user, e.g., 34 degrees Fahrenheit, the controller-processor 160 provides an output signal 208 to a valve 210 located in a drip line 212. A flow controller 214 located in the drip line 212 limits the flow to a water stream sufficient to avoid frozen water pipes. The drip line stream of water is discharged to a drain 216.

It will be understood by one skilled in the art that the automatic implementation of freeze-prevention measures, as described with respect to FIG. 4, conserves water by preventing frozen pipes. Similarly, the control of line pressure by the use of a pressure regulator conserves water by preventing failure of piping systems due to excessive line pressures.

The controller-processor 160 can also be programmed with multiple set points with corresponding preventive and/or corrective action. As described with respect to FIG. 4, the controller-processor 160 will open the valve 190 in the drip line 192 if the temperature sensor 182 provides an input signal 183 to the controller-processor indicating that the temperature is near or below freezing. If the temperature sensor 182 indicates the temperature is approaching zero degrees, i.e., a severely cold temperature, the controller-processor can, if desired, close the control valve 26 in the building water supply line 24 in addition to opening the valve 190 in the drip line 192. With drip lines open and water supply interrupted, the danger of frozen piping is further reduced. One of the inputs to the controller-processor provides an indication of whether the building is occupied or unoccupied. The occupied/unoccupied status could be entered through the user interface, or the occupied/unoccupied status could be obtained from an existing security system controller. If the building is unoccupied during severely cold weather, it may be desirable to both open the drip lines and also close the water valve 26 in the building water supply line 24.

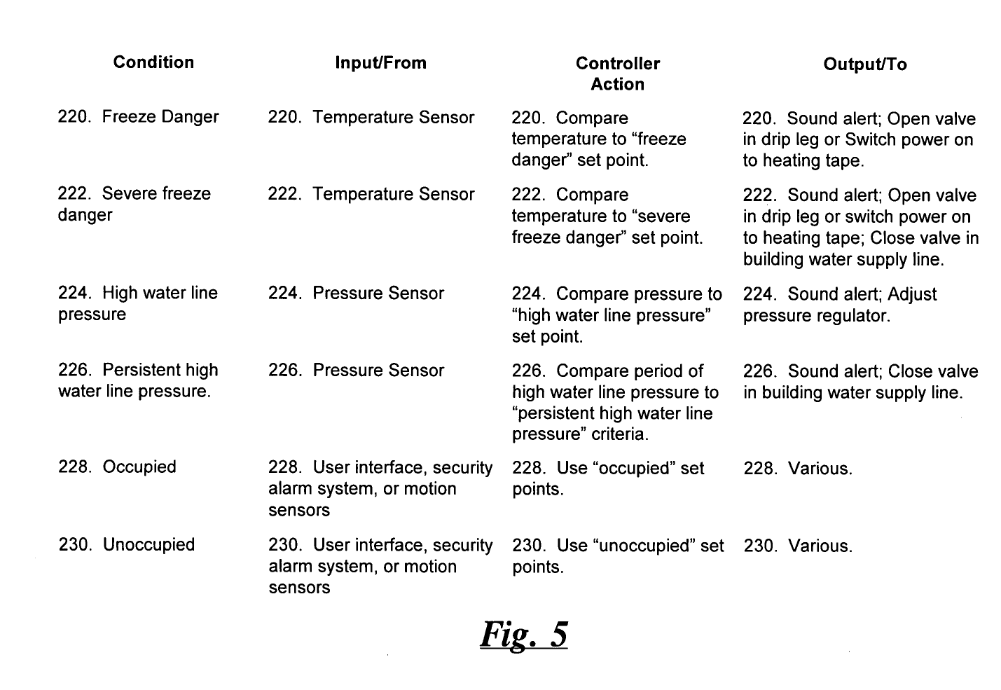

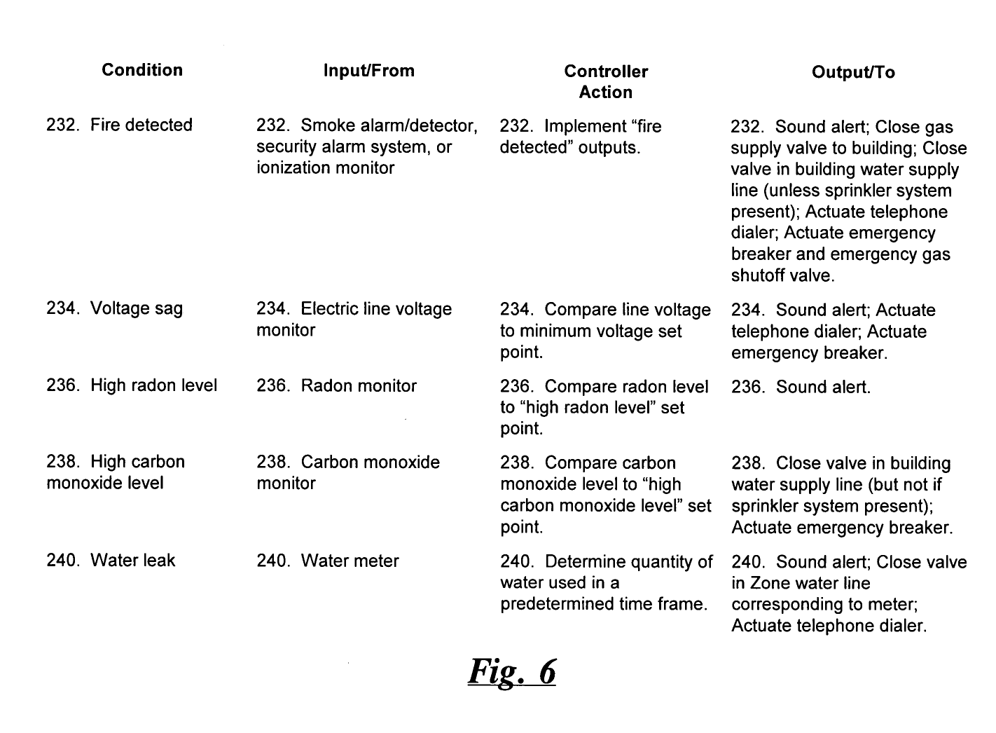

Referring now to FIGS. 5 and 6, the tables shown therein provide inputs, controller actions, and outputs corresponding to specific conditions. In FIG. 5, reference number 220 relates to a “freeze danger” condition as indicated by a temperature sensor (See FIG. 4). The controller-processor 160 compares the temperature to a “freeze danger” set point entered by the user through the user interface 164 (See FIG. 3). If the measured temperature is less than the “freeze danger” set point temperature, the controller sounds an alert and either opens a valve in a drip leg (See FIG. 4) or switches power on to a heating tape attached to the freeze-prone pipe section. Reference number 222 relates to a “severe freeze danger” condition as indicated by a temperature sensor (See FIG. 4). The controller-processor 160 compares the temperature to a “freeze danger” set point entered by the user through the user interface 164 (See FIG. 3). If the measured temperature is less than the “freeze danger” set point temperature, the controller-processor 160 sounds an alert and either opens a valve in a drip leg (See FIG. 4) or switches power on to a heating tape attached to the freeze-prone pipe section. In addition, the controller-processor 160 closes the valve 26 in the building water supply line 24, but only after checking to determine whether user input shows the presence of a fire-prevention sprinkler system. If a sprinkler system is present, logic circuitry in the controller-processor 160 prevents closure of the valve 26 in the building water supply line 24.

Still referring to FIG. 5, reference number 224 relates to a “high water line pressure” condition as indicated by a pressure sensor (See FIG. 4) in a selected water line location. The controller-processor 160 compares the measured pressure to a “high water line pressure” set point entered by the user through the user interface 164. If the measured water line pressure equals or exceeds the high water line pressure set point, the controller-processor 160 sounds an alert and actuates the pressure regulator 186 in the building water supply line 24 (See FIG. 4). If the measure water pressure qualifies as a persistent high water line pressure (reference number 226), the controller-processor sounds an alert and closes the valve 26 in the building water supply line 24 to protect building piping. The “persistent high pressure” set point combines a user-entered high pressure with a user-entered persistence time. Such a condition might suggest the pressure regulator 186 is not adequately protecting the piping from the danger of failure due to high water line pressure.

Still referring to FIG. 5, reference numbers 228, 230 relate to the status of building as “occupied” or “unoccupied.” The occupation status of the building is derived from user-entered information, from an existing security alarm system, or from motion sensors providing input to the controller-processor 160. The occupation status is especially important with respect to the present invention, which permits the user to enter a family profile matching the family's schedule of occupancy. If the building is occupied, a sound alert may be sufficient to notify occupants of a particular problem. If the building is unoccupied, however, something more may be required. The present invention also provides for entry of the number of persons occupying the house for each part of the day.

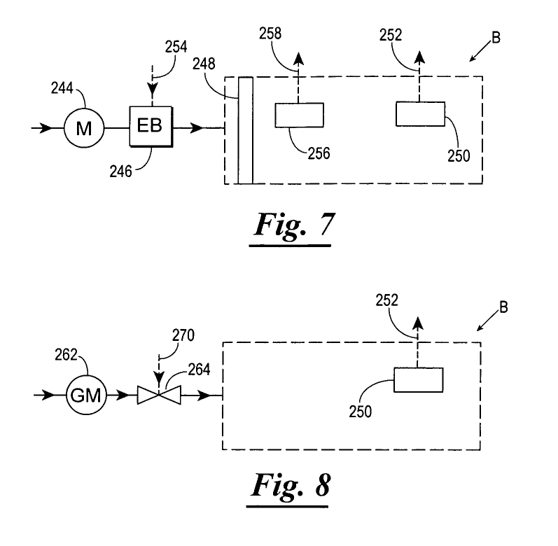

Referring now to FIG. 6 in conjunction with FIGS. 7 and 8, reference number 232 relates to a building status wherein a fire detection device 250 has detected a fire. The fire detection device 250 provides an input signal 252 to the controller-processor 160. The controller-processor 160 then actuates a telephone dialer, if programmed to do so by the user. The controller-processor 160 also provides an output to an emergency gas shutoff valve 264 to isolate the building B from the gas supplied to the building B through a gas supply line 260 and a gas meter 262. The controller-processor 150 also provides an output signal 254 to an emergency breaker 246 in the electrical power supply line 242.

Referring now to FIG. 6 in conjunction with FIG. 7, a reference number 234 refers to a voltage sag condition as indicated by a line voltage monitor 256 (See FIG. 7). The line voltage monitor 256 provides an input signal 258 to the controller-processor 160, which then provides an output signal 254 to the emergency breaker 246.

Referring still to FIG. 6, a reference number 236 refers to a high radon level condition as indicated by a radon monitor. A reference number 238 refers to a high carbon monoxide level as indicated by a carbon monoxide monitor. In each case, the controller-processor 160 receives an input signal from the radon or carbon monoxide monitor and compares the level to a set point entered by the user. On high levels of carbon monoxide, the controller-processor 160 sounds an alert, closes the emergency gas shutoff valve 264 (See FIG. 8), closes the valve 26 in the building water supply line 24 (unless the building B is equipped with a fire-suppression sprinkler system), and opens the emergency breaker 246 in the power supply line 242.

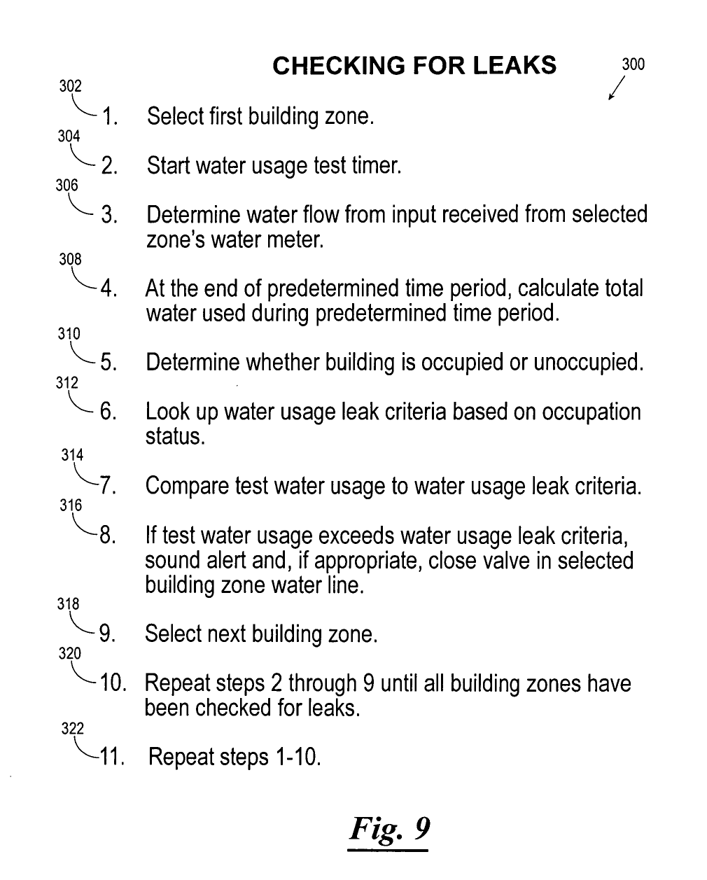

Still referring to FIG. 6, a reference number 240 relates to a “water leak” condition, as determined by the controller-processor 160 from an input from a water meter in a particular zone. The controller-processor 160 totals the amount of water used in a specified time period and compares the amount of water used to a predetermined maximum water usage. If the water usage exceeds the predetermined quantity, the controller-processor 160 provides an output to close a valve located in the zone wherein the leak is detected (See FIGS. 1-3). The process by which the controller-processor 160 detects a leak is set forth in detail in FIG. 9. Continuous flow of water for a specified time will be deemed a leak at a time when user input to the controller-processor identifies the building occupation status as “unoccupied” or “sleeping.”

Referring now to FIG. 7, electrical power is supplied to a building B by an electrical power line 242 through a power meter 244. A fire detection device 250 (e.g., smoke alarm, ionization monitor, or heat detector) in the building B provides an output signal 252 to the controller-processor 160 (See FIG. 2) when a fire is detected in the building B. The controller-processor provides an output signal 254 to an emergency breaker 246 so the emergency breaker opens and thereby removes all electrical power from the building B in the event of fire. The emergency breaker 246 can be powered by supply side low voltage, by a battery, or by air pressure. An electric line voltage monitor 256 provides an input signal 258 to the controller-processor 160 in the event the line voltage drops below a predetermined value. The controller-processor 160 provides an output signal 254 to the emergency breaker 246, which automatically opens and thereby protects electrical equipment in the building B from damage due to low voltage.

Referring now to FIG. 8, gas (natural gas or propane) is supplied to a building B by a gas supply line 260 through a gas meter 262. A fire detection device 2266 (e.g., smoke alarm, ionization monitor, or heat detector) in the building B provides an output signal 268 to the controller-processor 160 (See FIG. 2) when a fire is detected in the building B. The controller-processor provides an output signal 270 to an emergency gas shutoff valve 264. The emergency gas shutoff valve 264 can be powered by supply side low voltage, by a battery, or by air pressure.

Referring now to FIG. 9 in conjunction with FIG. 1, the process 300 by which the present invention checks for leaks is detailed. In a first step (302), the controller-processor 160 cycles to the input signal 44 from the water meter 40 located in the first building zone water line 36. In a second step (304), the controller-processor 160 then starts a water usage test timer utilizing an internal clock. The predetermined time period for the water usage test is selected based on (1) the anticipated water usage which would not be associated with a leak and (2) the anticipated water usage resulting from a leak. The anticipated water usage which would normally occur in the absence of a leak must take into consideration the occupancy status of the building and, if the building is occupied, the number of persons in the building. In addition, the anticipated water usage must take into account the time of day in light of the family profile. For two people working regular days and sleeping from about 11:00 p.m. until about 6:00 a.m., a water usage exceeding 10 gallons in 5 minutes during the sleeping period would normally be evidence of a leak.

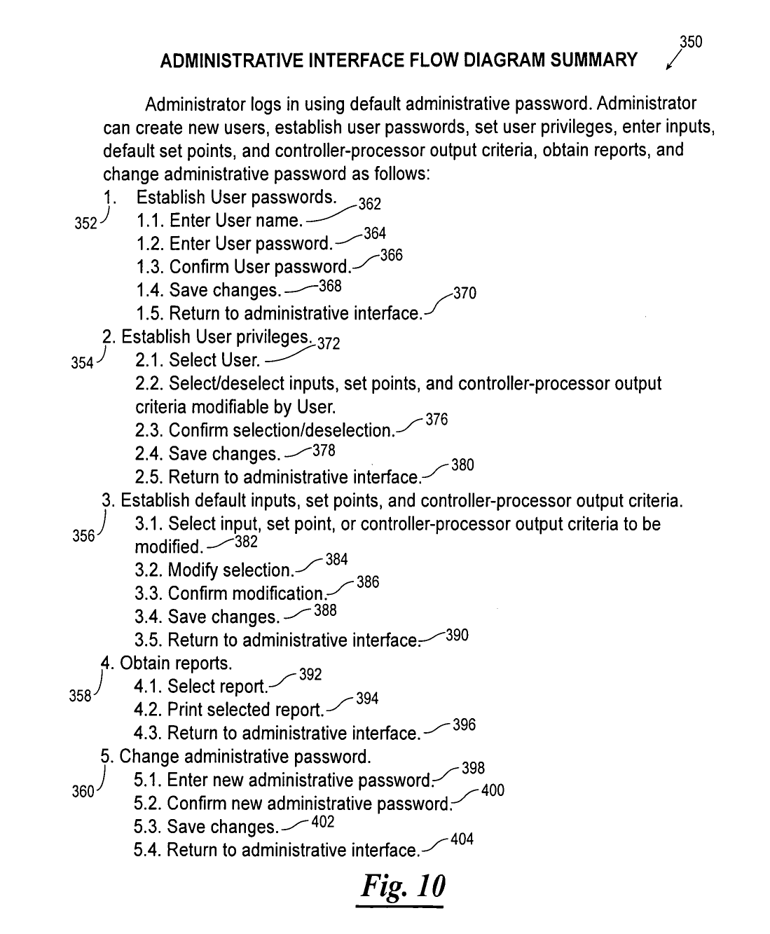

As used herein, a leak is defined as undesired water usage. The controller-processor 160 will thus deem water usage exceeding 10 gallons in a 5-minute period a leak, even if one of the occupants is unable to sleep and decides to wash clothes while simultaneously washing dishes. In those circumstances, the present invention will sound an alert and, if the building is occupied, the controller-processor 160 would not close a water valve in water line of the affected zone. The occupant would acknowledge the alarm and press an override key to prevent the controller-processor 160 from continuing to sound an alert. A defective fill mechanism in a commode might permit the commode fill line to run continuously for hours or even days. During the daytime hours with the building occupied, the amount of water usage deemed to be a leak would be significantly higher than 10 gallons over 5 minutes, so the running commode might not trigger a leak status with the controller-processor 160. During the sleep period, however, 10 gallons flowing through the meter 40 in 5 minutes will trigger a “leak alert.” The entry of information through the user interface is described in FIG. 10.

Still referring to FIG. 9, in step 306, the controller-processor 160 determines the water flow from the selected zone's water meter during the test period. In step 308, the controller-processor 160 calculates the total water used during the test period. In steps 310 and 312, the controller-processor 160 looks up water usage leak criteria based on occupation status. In step 314, the controller-processor compares actual water usage during the test period to water usage leak criteria. In step 316, the controller-processor 160 sounds a leak alert if the actual water usage during the test period exceeds the water usage leak criteria. If the building is unoccupied, the controller-processor 160 will also close the valve 38 in the Zone 1 water line 36, thereby effectively ending the loss of water due to the leak. As described in relation to FIG. 10, a reset feature allows the user to restore the zone having a leak to ready status through the user interface.

Still referring to FIG. 9, in step 318, the controller-processor 160 steps to the next building zone (combined Zones 1-2 in FIG. 1) and, in step 320, repeats steps 2-9 (304 through 318). When all building zones have been checked for leaks, the controller processor returns to the first building zone and begins the process of checking for leaks (step 322) once again.

Referring now to FIG. 10, an administrative interface flow diagram summary 350 describes the steps performed by the administrator. The administrator can establish user passwords (352), establish user privileges (354), establish default inputs, set points, and controller-processor output criteria (356), obtain reports (358) and change the administrative password (36). To establish a user password (352), the administrator enters a user name (362), enters a user password (364), confirms the user password (366), and saves changes (368). The administrator then returns to the administrative interface (370).

Still referring FIG. 10, to establish user privileges (354), the administrator selects a user (372), selects/deselects inputs, set points, and controller-processor output criteria which will be modifiable by the user (374), confirms the selected/deselected items (376) and saves changes (378). The administrator the returns to the administrative interface (380). To establish default inputs, set points, and controller-processor output criteria (356), the administrator selects an input, set point, or controller-processor output criteria to be modified (382), modifies the selected input, set point, or controller-processor output criteria (384), confirms the modification (386), and saves the changes (388). The administrator then returns to the administrative interface (390).

Still referring to FIG. 10, to obtain reports (358), the administrator selects a report (392) and prints the selected report (394) via an RS-232 or other data communication port, which are known in the art. The administrator then returns to the administrative interface (396).

It will be understood by on skilled in the art that the present invention's capacity to generate reports enables a homeowner or building superintendent to review water usage for the preceding day, week, month, or year—not just for the residential or commercial building as whole, but for any zone containing a water meter. In FIG. 4, for example, a report for the water usage as measured by the building supply line meter 30 will provide the total usage of water for Zones 1-3. Data obtained from the Zone 1 water meter 40 and stored in the controller-processor permits the administrator to generate a water usage report for Zone 1, and data obtained from the Zones 2-3 water meter 52 and stored in the controller-processor permits the administrator to generate a water usage report for combined Zones 2 and 3. As indicated above, the piping diagram of FIG. 4 might correspond to a residence wherein Zone 1 contains a landscaping irrigation system and exterior water faucets, while Zone 2 contains interior bathrooms and showers, and Zone 3 contains the kitchen water-using devices (e.g., a sink, a dishwasher, and an ice maker) together with the clothes washer 98 located in an adjacent laundry room.

Referring to FIG. 10 in conjunction with FIG. 1, it will understood by one skilled in the art that the present invention is especially suited for use in large homes and commercial buildings where a commode might continue to run continuously for days or weeks before the problem is discovered.

Referring again to FIG. 10, to change the administrative password (360), the administrator enters a new administrative password (398), confirms the new administrative password (400), and saves the changes (402). The administrator then returns to the administrative interface (404).

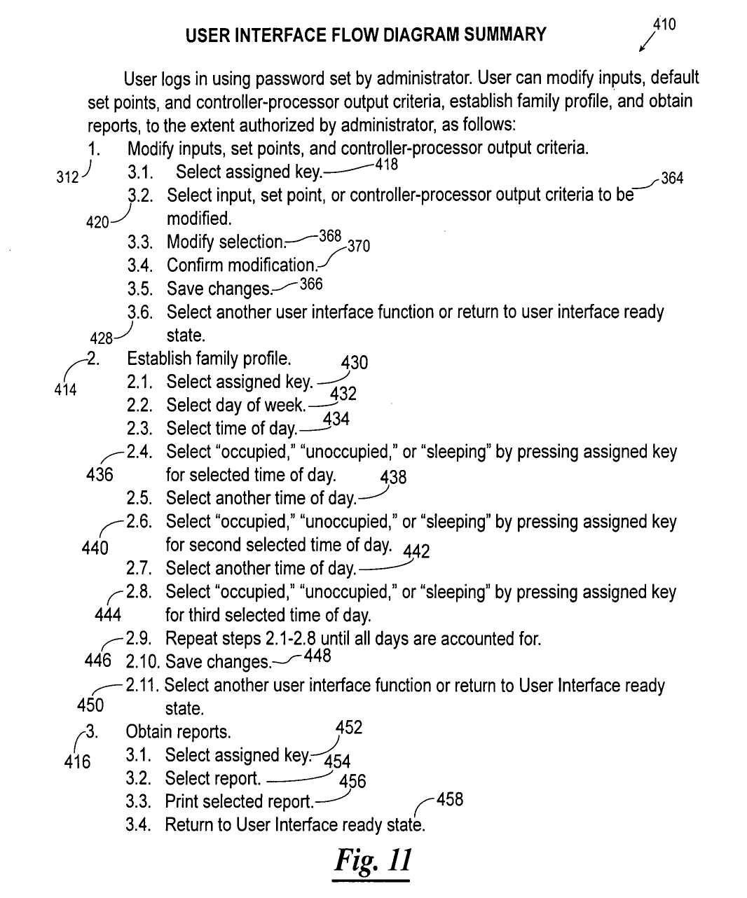

Referring now to FIG. 11, a user interface flow diagram summary 410 describes steps performed by a user. The user can modify inputs, set points, and controller-processor output criteria (412), establish a family profile (414), and obtain reports (416). To modify inputs, set points, and controller-processor output criteria (412), the user selects an assigned key (418), selects an input, set point, or controller-processor output criteria to be modified (420), modifies the selection (422), confirms the modification (424), and saves changes (426). The user then selects another user interface function or returns to the user interface ready state (428).

Still referring to FIG. 11, to establish a family profile (414), the user selects an assigned key (430), selects a day of the week (432), selects a time of day (434), selects “occupied” status, “unoccupied” status, or “sleeping” status by selecting a corresponding key (436), and then selects another time of day (438). For the second time of day, the user selects “occupied” status, “unoccupied” status, or “sleeping” status by selecting a corresponding key (440), and then selects another time of day (442). For the third time of day, the user selects “occupied” status, “unoccupied” status, or “sleeping” status by selecting a corresponding key (444). The user then repeats steps 2.1-2.8 until all days of the week are accounted for (446) and saves the changes (448). The user then selects another user interface function or returns to the user interface ready state (450).

Still referring to FIG. 11, to obtain reports (416), the user selects an assigned key (452), selects a report (454), and prints the selected report (456). The user then returns to the user interface ready state (458).

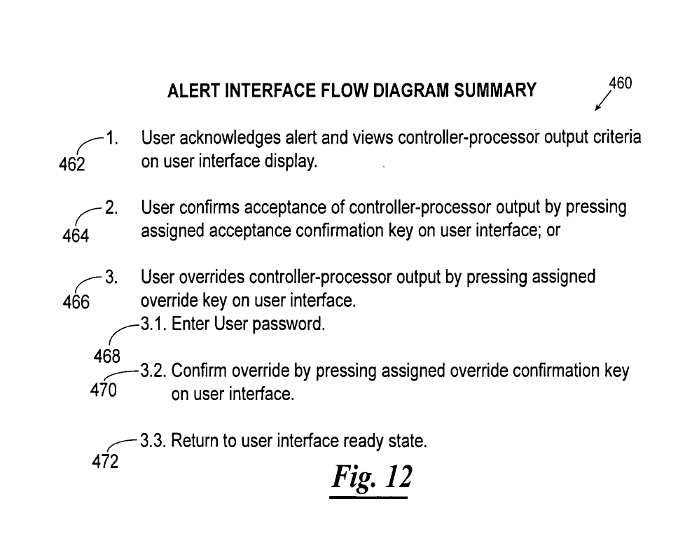

Referring now to FIG. 12, an alert interface flow diagram summary 460 describes steps performed by a user in response to an alert. The user can acknowledge the alert and view the controller-processor output criteria on the user interface display (462), confirm acceptance of the controller-processor output by pressing an assigned acceptance confirmation key (464), or press an assigned override key to override the controller-processor output (466). To override the controller-processor output, the user first enters the user's password (468), confirms the override by pressing an assigned override confirmation key on the user interface (470), and then returns to the user interface ready state (472).

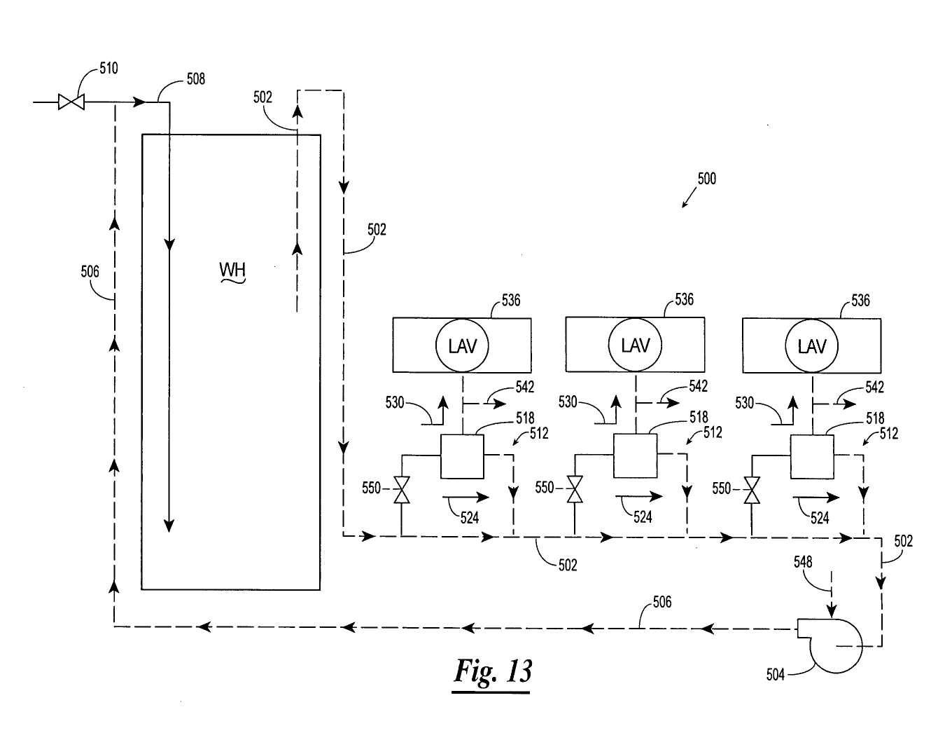

Referring now to FIG. 13, a water-saving hot water system 500 eliminates the common practice of running water to the sanitary drain until water from the hot water faucet advances from cold to warm to hot. A hot water supply line 502 carries hot water from a water heater WH to the suction side of a pump 504. The pump 504 returns water through a return line 506 to the cold water supply line 508. A check valve 510 forces the returned hot water to return to the water heater WH. Water from the hot water supply line 502 is fed through loops 512, 514, and 516 (also sometimes to referred to as slipstreams 512, 514, and 516) to thermostats 518, 520, and 522, respectively. Until the thermostats 518, 520, and 522 heat up to a design opening temperature, e.g., 120-140 degrees Fahrenheit, the water flows along arrows 524, 526, 528 back to the hot water supply line 502. Once the hot water reaches the design opening temperature, the thermostats 518, 520, 522 open to permit hot water to flow along arrows 530, 532, and 534 to lavatories 536, 538, and 540, respectively. A user's opening of hot water faucets (not shown) at any of the lavatories 536, 538, 540 results in the closure of switches 542, 544, 546, respectively, and energizes the electrical circuit powering the pump 504.

In operation, a user opens a faucet at one of the lavatories 536, 538, 540 and simultaneously actuates a corresponding switch 542, 544, or 546. The pump 504 begins to pump water through the hot water return line 506 back to the water heater WH, but no water will be delivered to the user because the thermostats 518, 520, 522 will not have heated to their design opening temperature. Only after the thermostat associated with the open faucet has reached its design opening temperature will water be discharged from the faucet. The water so discharged will be hot water, and no water has been discharged to drain while the hot water system 500 heats up.

It will be understood by one skilled in the art that the thermostats 518, 520, and 522 can be replaced by 3-way valves which are opened when a corresponding temperature sensor (See the temperature sensors 182 and 204 in FIG. 4) indicates the loops 512, 514, 516 have reached a preselected hot water operating temperature.

Referring now to FIG. 13 in conjunction with FIGS. 2 and 11, the controller-processor 160 of the present invention can be programmed to provide an output signal 548 to the pump 504 at a specific time of day, e.g., a few minutes before the family normally arises each morning, thereby providing virtually instant hot water for the family while avoiding running water down the drain.

It will be understood by one skilled in the art that actuation of the switches 542, 544, 546 can, in addition to starting up the pump 504, open valves 550, 552, and 554, respectively, so hot water is circulated only to the loop associated with the actuated switch.

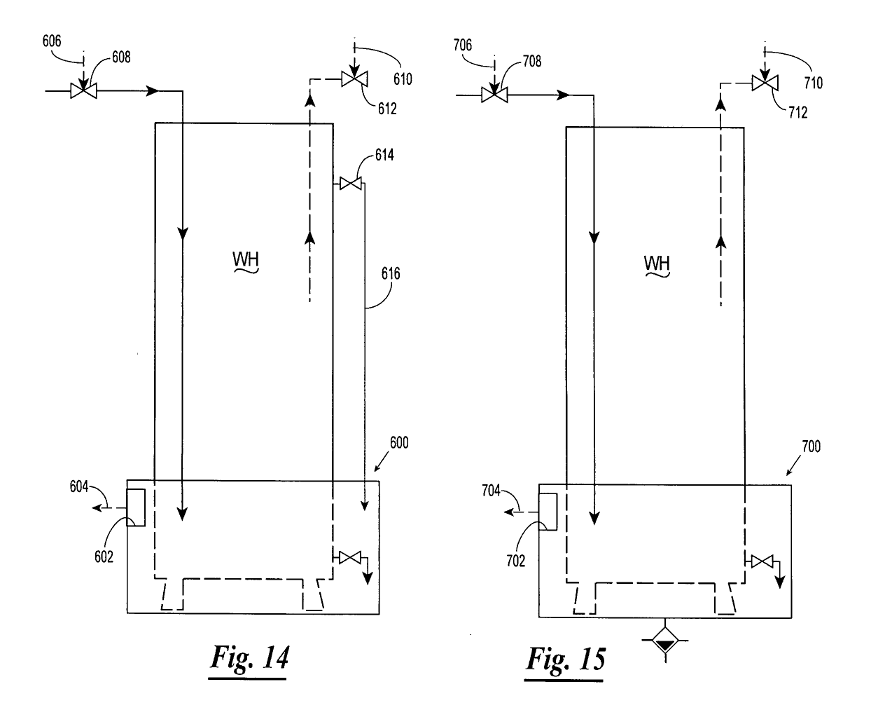

Referring now to FIG. 14, a hot water catchment 600 is positioned beneath a water heater WH so that hot water leaking from the water heater WH is retained within the catchment 600. A water level sensor 602 provides an input signal 604 to a controller-processor (such as the controller-processor 160 shown in FIGS. 2 and 3). In response to the water level sensor input signal 604, the controller-processor provides an output signal 606 to close a cold water supply line valve 608 and an output signal 610 to close a hot water line valve 612. When the valves 608 and 612 are closed, very little additional water will flow into the catchment 600.

Still referring now to FIG. 14, a temperature pressure relief valve (TPR valve) 614 releases water (and thus relieves pressure) if either the temperature or pressure in the water heater tank gets too high. These valves are very important. Water heaters can become bombs if the pressure gets too high and these valves fail to work. Moreover, TPR valves should be tested from time to time to be sure they are working properly. A drain line 616 attached to the TPR valve 614 directs hot water to the catchment 600.

Referring now to FIG. 15, a hot water catchment 700 is positioned beneath a water heater WH so that hot water leaking from the water heater WH is retained within the catchment 700. A water level sensor 702 provides an input signal 704 to a controller-processor (such as the controller-processor 160 shown in FIGS. 2 and 3). In response to the water level sensor input signal 704, the controller-processor provides an output signal 706 to close a cold water supply line valve 708 and an output signal 710 to close a hot water line valve 712. When the valves 708 and 712 are closed, very little additional water will flow into the catchment 700. A water trap 714 drains any water collected in the catchment 700 to sanitary drain.

It will be understood by one skilled in the art that the catchment 700 of FIG. 15 is best suited for new home construction because of the need for a conveniently located sanitary drain. The catchment 600 of FIG. 14 is suitable for installation in conjunction with existing water heaters.

It will be further understood by one skilled in the art that valves used herein may be either energized closed valves or energized open valves. If the valves 26, 38, 50, 78, 98, 128, and 148 are energized closed valves, the output signals 28, 46, 64, 92, 112, 136, and 156, respectively, from the controller-processor 160 will supply power to the valves and cause the normally open valves to close. If, on the other hand, the valves 26, 38, 50, 78, 98, 128, and 148 are energized open valves, the output signals 28, 46, 64, 92, 112, 136, and 156, respectively, from the controller-processor 160 will cause power to be removed from the valves and the valves will return to a normally closed position.

In FIG. 7, the invention has been described in the context of a normally open emergency breaker 246 which is caused to break by the output signal 254 from the controller-processor 160. The use of a normally closed emergency breaker would stay closed until power is withdrawn and would then break the circuit without application of external power. Similarly, the emergency shutoff valve 264 in FIG. 8 is described as closing in response to the output signal 270 from the controller-processor 160, but the emergency gas shutoff valve could just as easily be an energized open valve and close when power is withdrawn. Either normally closed valves and breakers or normally open valves and breakers are within the scope and spirit of the present invention. Normally open valves and breakers will close in response to an output signal from the controller-processor which causes the valves and breakers to be energized. Normally closed valves and breakers will open in response to an output signal from the controller-processor which causes the valves and breakers to be de-energized.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A device for detecting water system leaks and preventing excessive water usage by water systems in residential and commercial buildings, comprising:
a processor;
a user interface for programming the processor with at least one preselected controller output criteria;
at least one water meter located in a water line within the building, wherein the water meter provides a water flow input signal to the processor;
at least one water line valve responsive to an output signal from the processor; and
wherein the processor calculates water usage based on the water flow input signal received from the water meter, compares the calculated water usage to the preselected controller output criteria, and provides an output signal to the water meter if the calculated water usage satisfies the preselected controller output criteria, thereby closing the valve in the water line and preventing further water usage.

2. The device of claim 1 wherein the water system is divided into at least two zones wherein a water meter is located in the water line supplying each zone, wherein a water line valve is located in the water line supplying each zone, and wherein the processor calculates water usage based on the water flow input signal received from the water meter for each zone, compares the calculated water usage for each zone to the preselected controller output criteria for each zone, and provides an output signal to the water line valve in any zone wherein the calculated zone water usage satisfies the preselected controller output criteria for that zone, thereby closing the valve in the water line in the affected zone and preventing further water usage.

3. The device of claim 2 wherein the processor stores water usage data for each zone and wherein the processor has a data communication port integral therewith, so the water usage data is available for printed reports of zone water usage for user-selected time periods.

4. The device of claim 1, further comprising;
at least one temperature sensor located in a freeze-prone location in the water line, wherein the temperature sensor provides a temperature input signal to the processor;
wherein the processor compares the sensed temperature to preselected freezing temperature controller output criteria and provides an output signal to the water line valve if the sensed temperature satisfies the preselected freezing temperature controller output criteria, thereby closing the valve in the water line and preventing excessive water usage.

5. The device of claim 4, wherein the water system further comprises a drip line discharging to drain, the drip line containing a valve responsive to an output signal from the processor, and wherein the processor provides a drip line output signal causing the drip line valve to open when the preselected freezing temperature controller output criteria are satisfied.

6. The device of claim 5, further comprising a flow controller disposed in the drip line between the drip line valve and the drain.

7. The device of claim 1, wherein the water system is further characterized as being connected to a supply system water meter, wherein the water system further comprises:
a pressure regulator located between the supply system water meter and the building water system;
a pressure sensor located at a selected location in the building water system, wherein the pressure sensor provides a water line pressure input signal to the processor; and
wherein the processor compares the sensed water line pressure to preselected high water line pressure controller output criteria and provides an output signal to the pressure regulator if the sensed water line pressure satisfies the preselected high water line pressure controller output criteria, thereby causing the pressure regulator to reduce the building water system pressure and preventing damage to system water lines from high water pressure.

8. The device of claim 1, further comprising;
at least one temperature sensor located in a freeze-prone location in the water line, wherein the temperature sensor provides a temperature input signal to the processor;
a drip line discharging to drain, wherein the drip line contains a valve responsive to an output signal from the processor; and
wherein the processor provides a drip line output signal causing the drip line valve to open when the preselected freezing temperature controller output criteria are satisfied.

9. The device of claim 1, wherein the processor is integrated with a security alarm system.

10. The device of claim 5, further comprising a water-saving hot water system for use in conjunction with a water heater, the water heater being characterized as having a cold water supply line and a hot water line, the water-saving hot water system comprising:
a pump attached at the pump suction to the hot water line and at the pump discharge to a hot water return line whereby the pump returns water to the water heater, the hot water return line connecting to the cold water supply line just ahead of the water heater;
at least one slipstream off the hot water line whereby the slipstream hot water is routed through a thermostat having an inlet, a cold water outlet, and a hot water outlet, the thermostat opens the hot water outlet only when the thermostat is heated to an elevated design operating temperature;
a faucet hot water line connected to the hot water outlet of the thermostat;
a hot water faucet attached to the faucet hot water line;
a hot water faucet switch attached to the hot water faucet, wherein opening of the hot water faucet closes the switch, and wherein closure of the switch energizes the pump in the hot water line;
an override switch for switching on the pump without closure of the hot water faucet switch;
wherein, when a user opens the hot water faucet, the pump circulates water in the hot water line from the water heater, through the slipstream, and back to the water heater via the hot water return line;
wherein, so long as water in the hot water line and the slipstream is cooler than the elevated operating temperature of the thermostat, the slipstream hot water is returned to the water heater;
wherein, when the water in the slipstream reaches the elevated design operating temperature of the thermostat, the thermostat opens and hot water flows from the slipstream through the hot water outlet of the thermostat, through the faucet hot water line, and out the faucet; and
wherein the override switch is actuated by an override switch output signal from the controller-processor based on a schedule of occupancy of the building stored in the controller-processor.

11. The device of claim 5, further comprising a catchment for use in conjunction with a water heater having a cold water supply line, a hot water line, and a temperature pressure relief valve, the catchment comprising:
a container disposed beneath the water heater, the container having a bottom and an upstanding sidewall and a container capacity equal to the capacity, in gallons, of the hot water heater, the container extending upwardly along the outside of the water heater so water leaking from the hot water heater is received by the container;
a water level sensor attached to an upper inside portion of the upstanding sidewall, the level sensor providing an input signal to the controller-processor;
a cold water line valve located in the cold water supply line adjacent the water heater, the cold water line valve being responsive to an output signal from the controller-processor;
a hot water line valve located in the hot water line adjacent the water heater, the hot water line valve being responsive to an output signal from the controller-processor;
a temperature pressure relief valve discharge line extending from the opening of the temperature pressure relief valve downwardly to a position just inside the upstanding sidewall of the container so that water from the temperature pressure relief valve is received by the container; and
wherein accumulation of sufficient water within the container to actuate the water level sensor results in an input signal to the controller-processor and the controller-processor provides a simultaneous output signal to the cold water line valve and the hot water line valve, thereby closing the line valves preventing flow of additional quantities of water from the leaking water heater into the container.

12. A method for detecting water system leaks and preventing excessive water usage in residential and commercial buildings, the method comprising the steps of:
placing at least one water meter in the water system;
placing a normally open valve upstream of the water meter;
providing a controller-processor programmed with predetermined output criteria based on water usage;
establishing water usage criteria indicative of a leak or pipe failure in the water system;
comparing actual water usage based on an input signal from the water meter with the established water usage criteria indicating a leak or pipe failure in the water system; and
providing an output signal to the normally open valve if the actual water usage satisfies the predetermined output criteria, so the normally open valve is caused to close and water losses are minimized.

13. The method of claim 12, further comprising the steps of:
dividing the building water system into at least two zones;
placing a water meter in the water line supplying each zone;
placing a water line valve in the water line supplying each zone;
utilizing the controller-processor to calculate water usage based on the water flow input signal received from the water meter for each zone;
comparing the calculated water usage for each zone to the preselected controller output criteria for each zone; and
providing an output signal to the water line valve in any zone wherein the calculated zone water usage satisfies the preselected controller output criteria for that zone, thereby closing the valve in the water line in the affected zone and preventing further water usage.

14. The method of claim 13, comprising the additional steps of:
storing water usage data for each zone in the processor;
providing the controller-processor with an integral data communication port;
providing a printer for connection to the data communication port; and
wherein the water usage data is available for printed reports of zone water usage for user-selected time periods.

15. The method of claim 12, comprising the additional steps of:
placing at least one temperature sensor in a freeze-prone location in the water line, wherein the temperature sensor provides a temperature input signal to the processor;
utilizing the processor to compare the sensed temperature to preselected freezing temperature controller output criteria; and
providing an output signal to the water line valve if the sensed temperature satisfies the preselected freezing temperature controller output criteria, thereby closing the valve in the water line and preventing excessive water usage in the event water freezes in the water line.

16. The method of claim 15, comprising the additional steps of:
placing at least one temperature sensor in a freeze-prone location in the water line, wherein the temperature sensor provides a temperature input signal to the processor;
utilizing the processor to compare the sensed temperature to preselected freezing temperature controller output criteria;
placing a drip line in a convenient location in the water system, wherein the drip line contains a valve responsive to an output signal from the processor;
utilizing the processor to provide drip line output signal when the preselected freezing temperature controller output criteria are satisfied, so the drip line output signal causes the drip line valve to open to prevent water from freezing in the water line.

17. The method of claim 12, comprising the additional steps of:
placing at least one temperature sensor in a freeze-prone location in the water line, wherein the temperature sensor provides a temperature input signal to the processor;
utilizing the processor to compare the sensed temperature to preselected freezing temperature controller output criteria;
placing a drip line in a convenient location in the water system, wherein the drip line contains a valve responsive to an output signal from the processor;
utilizing the processor to provide drip line output signal when the preselected freezing temperature controller output criteria are satisfied, so the drip line output signal causes the drip line valve to open to prevent water from freezing in the water line.

18. The method of claim 17, comprising the additional steps of:
providing a sound generator integral with the controller-processor; and
sounding an alert whenever any controller output criteria are satisfied.

19. The method of claim 18, comprising the additional steps of:
storing information in the controller-processor as to when the building is occupied and unoccupied;
establishing controller output criteria as a function of the building occupation status; storing the status-dependent controller output criteria in the controller-processor; and
utilizing the stored status-depended controller output criteria selecting the controller when determining a response to input signals to the controller-processor.

20. The method of claim 19, wherein the controller-processor receives the building occupation status from a security alarm system.
